(19) United States
(12) Patent Application Publication
(10) Pub. No.: US 2004/0252491 A1
(43) Pub. Date: Dec. 16, 2004

(54) Printed circuit board lamp

(75) Inventor: Kevin L. Parsons, Appleton, WI (US)

Correspondence Address: WELSH & KATZ, LTD, 120 S RIVERSIDE PLAZA, 22ND FLOOR, CHICAGO, IL, 60606, US

(73) Assignee: Armament Systems and Procedures, Inc., Appleton, WI

(21) Appl. No.: 10/458,094

(22) Filed: Jun. 10, 2003

(51) Int. Cl. F21L 2/00

(52) U.S. Cl. 362/157

(57) ABSTRACT

A flashlight is disclosed for use in environments with relatively high levels of vibration forces acting along a predominant axis of light emission of the flashlight. The flashlight includes a lamp having a pair of leads extending rearwardly from the lamp parallel to the predominant axis of light emission and a printed circuit board disposed perpendicular to the predominant axis of transmission. The flashlight further includes a pair of receptacles disposed in the printed circuit board and adapted to receive the pair of leads of the lamp and a conductive adhesive disposed within the receptacles to secure the leads of the lamp within the receptacles of the printed circuit board.

### FIELD OF THE INVENTION

The present invention relates generally to flashlights, and more particularly to flashlights that in use are subjected to substantial reversible shock forces acting generally longitudinally of the flashlight.

### BACKGROUND OF THE INVENTION

The concept of mounting flashlights on guns is a relatively recent innovation. Prior art flashlights used lamps that were inefficient and required relatively large batteries. Past efforts to mount flashlights on guns have resulted in combinations that were cumbersome and prohibitively heavy. Further, the market for flashlights mountable on guns is limited. For example, sportsmen involved in hunting are typically not allowed to hunt after dusk. Consequently, a flashlight mounted on a sport gun is of little value to a sportsman.

In contrast, military and law enforcement agencies are frequently called upon to operate at night and under a variety of environmental conditions. However, when used in combat or law enforcement situations, the failure of a gun-mounted flashlight could result in serious endangerment to the user. For example, if a soldier or law enforcement officer were to attempt to illuminate a target while arming his weapon, but before firing his flashlight malfunctioned or operated intermittently, any momentary illumination from the flashlight could reveal the soldier's or officer's position and cause the soldier or officer to become the target of return fire.

Recent advances in weapons technology have provided a number of relatively light, reliable, hand-holdable rapid firing weapons either of an automatic fire pistol or “machine gun” type. Light illumination sources have also been developed for use with the new weapons technology that provide a high ratio of light ray output to weight. In general, any combination of lithium, NiCd or air-cell batteries used in conjunction with halogen or xenon lamps provide a relatively high light output to weight ratio. When combined with aluminum or strong plastic housings and fittings, the result is a lightweight, relatively durable combination.

One successful combination includes the use of lithium batteries and xenon lamps. Xenon lamps may be constructed of a high pressure glass. Unlike quartz lamps, xenon lamps may be handled and easily replaced within conventional flashlights. To replace a xenon lamp, a user may simply remove a lens ring and take out a reflector assembly. The reflector assembly may include the reflector and a lamp assembly. The lamp assembly generally includes an adjuster that holds the xenon lamp. Typically, the xenon lamp has a pair of leads that are inserted into the adjuster. The adjuster may then be screwed into the reflector assembly. The distance that the adjuster is screwed into the reflector may be used to control focus.

While such combinations have been somewhat successful, they have generally failed to meet the harsh requirements of military or law enforcement applications. When combined with rapid fire automatic weapons, conventional flashlight technology often fails due to factors such as vibration forces. Accordingly, a need exists for flashlight technology that is both lightweight and also resistant to shock forces.

### BRIEF SUMMARY OF THE INVENTION

In carrying out the present invention, a flashlight is provided for use in environments wherein the flashlight is subjected to relatively high levels of vibration forces acting along a predominant longitudinal axis of light ray emission of the flashlight. The flashlight includes a light source in the form of a high pressure, high intensity, incandescent lamp having a pair of leads extending rearwardly from the lamp generally parallel to the predominant axis of light emission rays. A printed circuit board is disposed generally transverse to the predominant axis of light transmission. The flashlight further includes a pair of receptacles disposed in the printed circuit board and adapted to receive the leads of the incandescent lamp. A conductive adhesive is disposed within one or both of the receptacles to secure the leads of the lamp within the receptacles of the printed circuit board. Alternatively, the conductive adhesive may be injected into one or both of the receptacle after the leads of the lamp have been installed. In general, the steps of the process may be practiced in any order. In this manner, the LED leads are not displaced from the circuit board when subjected to high reciprocating forces as experienced with prior flashlights having their leads inserted into receptacles in the circuit board but not fixedly secured therein.

Accordingly, one of the primary objects of the present invention is to provide a technique for securing the leads of an incandescent lamp light source to a printed circuit board in a flashlight so as to prevent dislodgement of the leads from the circuit board when the flashlight is subjected to high reciprocating forces acting substantially in the direction of the light rays emitted from the flashlight.

Another object of the present invention is to provide a flashlight that employs a printed circuit board disposed generally transverse to the longitudinal axis of the flashlight and has the leads of an incandescent lamp secured in receptacles in the circuit board by an adhesive so as to prevent the leads dislodgement from the circuit board when subjected to significantly high shock forces acting on the leads in a direction generally normal to the circuit board.

A feature of the present invention lies in providing a flashlight as aforedescribed that facilitates attachment to a weapon, such as a machine gun, and that is constructed to withstand significantly high reciprocating forces acting in the axial direction of the light source leads during operation of the machine gun.

Further objects, features and advantages of the present invention will become apparent from the following description of a preferred embodiment of the invention when taken in conjunction with the accompanying drawings wherein like reference numerals designate like elements throughout the several views.

### BRIEF DESCRIPTION OF THE DRAWINGS

FIG. 1 is a side elevational view of a gun having a flashlight made in accordance with the present invention mounted thereon;

FIG. 2 is an exploded elevational view of the flashlight of FIG. but with internal power source batteries being shown in phantom;

FIG. 3 depicts a lamp holder assembly of the type employed in the flashlight of FIG. 2, portions being shown in longitudinal section for clarity;

FIG. 4 is an exploded view of the lamp holder assembly of FIG. 3; and

FIG. 5 depicts, on an enlarged scale, a lamp assembly as employed in the lamp holder assembly of FIG. 4.

### DETAILED DESCRIPTION

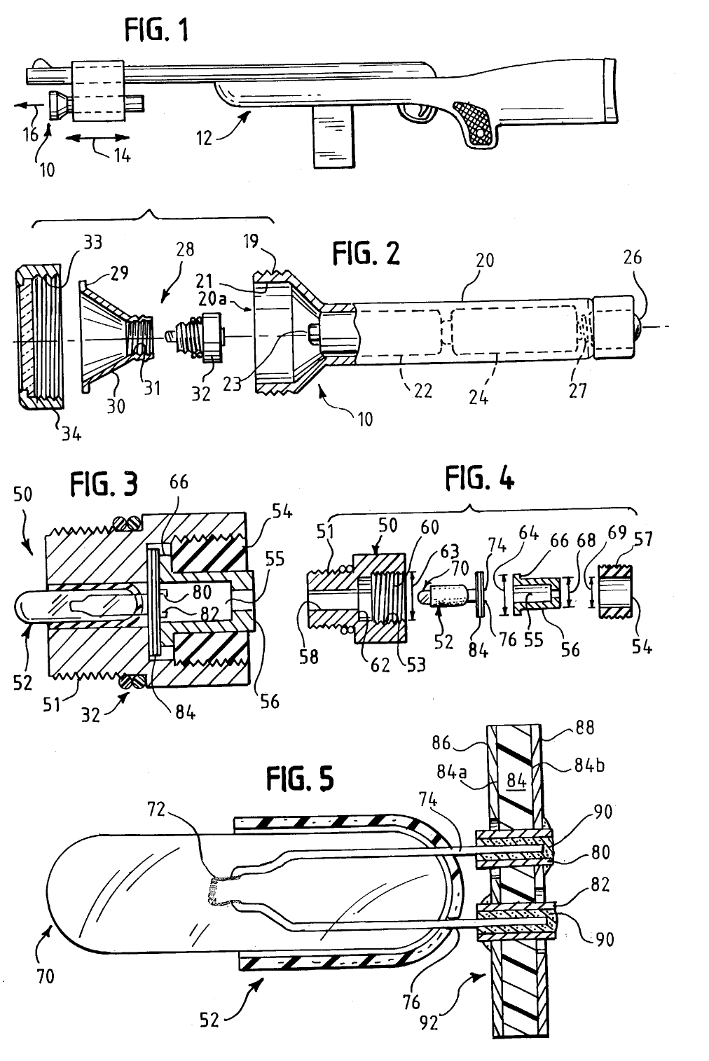

Referring now to the drawings, FIG. 1 depicts a flashlight 10 employing a vibration resistant light source in accordance with the present invention attached to a machine gun 12. As illustrated, the flashlight 10 is attached to the machine gun 12 so that a predominant axis of light ray emission 16 from the flashlight is substantially parallel with the direction of gunfire from the machine gun 12.

As the machine gun 12 fires, the detonation of the gunpowder inside each cartridge fired imparts a backward impulse to the machine gun 12 that must be overcome by the user (not shown). Further, in the case of a gas-operated breech, the firing of each cartridge causes the breech to automatically open and close as each spent cartridge is ejected and each new cartridge is loaded. The net effect of firing the machine gun 12 is to impart significant vibration forces 14 to the flashlight 10 acting in a direction substantially parallel to the axis of light ray emission from the flashlight.

As shown in FIG. 2, the flashlight 10 includes a generally tubular body 20 that houses one or more batteries such as 1.5-volt alkaline batteries 22, 24, a switch 26 and a light assembly 28. The light assembly 28 also includes a lamp holder assembly 32, a reflector assembly 30 and a retaining ring 34. The lamp holder assembly 32 includes a generally tubular-shaped impulse housing 50 made of a suitable electrically conductive material, a lamp assembly 52, an electrically conductive spacer 56, and an electrically nonconductive insulating collar 54 as illustrated in FIGS. 3 and 4.

Referring to FIG. 4, the housing 50 has a stepped internal cylindrical passageway defining a lamp receiving portion 58 and a printed circuit PC board receiving portion 60 separated by an annular shoulder 62.

As illustrated in FIG. .5, the lamp assembly 52 includes a lamp 70 and a PC board assembly 92. The lamp 70 is preferably a high pressure, high intensity incandescent lamp having a filament 72, first and second leads 74, 76, and an elastomeric sheath 78. The elastomeric sheath 78 surrounds the outer circumference of the lamp in which filament 72 is embedded and functions to cushion the quartz or high temperature envelope of the lamp from transverse vibrations.

The PC board assembly 92 includes a circular-shaped fiberglass board 84 having parallel planar external surfaces 84a and 84b. First and second electrically conductive receptacles 80 and 82, that may be formed as tubular-shaped brass fittings, are secured to the board 84 by pre-drilling suitable size cylindrical holes equidistant from the center of the board 84 so as to lie on a common diameter and press fitting or swaging the receptacles 80, 82 into the pre-drilled holes. The tubular receptacles 80, 82 define center passageways or apertures for receiving the leads 74, 76 of the lamp 70.

The PC board 84 has conductive coatings 86 and 88 formed on its opposite surfaces 84a and 84b, respectively, by appropriate known technology such as plating, lamination, etc. The conductive coating 86 is formed so as to make electrical contact with the first receptacle 80 without contacting receptacle 82, and the conductive coating 88 is formed to make electrical contact with the second receptacle 82 on the opposite side of the board 84 without contacting receptacle 80.

To form the lamp assembly 52, a suitable amount of an electrical conductive and flexible adhesive resin (glue) 90, such as available from Loc Tite under its Part No. 3882, is injected into each of the apertures passing through the receptacles 80, 82. Following injection of the adhesive 90, the leads 74, 76 are pressed into the apertures within the receptacles 80, 82 and the adhesive resin 90 allowed to cure by the application of heat or otherwise.

After the adhesive resin 90 has cured, the lamp assembly 52 may be assembled to the housing 50 (FIG. 3). The lamp receiving portion 58 and PC board receiving portion 60 of the housing 50 need only be slightly larger in diameter than an outer diameter of the elastomeric sheath 78 and PC board 84, respectively. Once the lamp assembly 52 has been inserted into the housing 50, the conductive coating 86 forms an electrical contact with the housing 50. Electrical contact with the conductive coating 88 is formed through the electrically conductive spacer 56.

The diameter 68 (FIG. 4) of the spacer 56 may be slightly smaller (e.g., 5 mils) than the inner diameter 69 of the insulated collar 54. In contrast, the outer diameter 64 of the flange 66 on spacer 56 may be significantly smaller (e.g., 100 mils) than the inner diameter 63 of the housing 50. The net effect of these differences in diameter is that the insulated collar 54 holds the spacer 56 in a centered position within the recess 60 in housing 50 such that the flange 66 only contacts the conductive surface 88 on the PC board 84 and cannot touch the adjacent inner cylindrical surface of recess 60 in housing 50. A hollow, cylindrical space or recess 55 within the spacer 56 allows the flange 66 to surround the receptacles 80, 82 without coming into contact with them.

To assemble the flashlight 10, the lamp assembly 52 may first be inserted into the housing 50 as above described. The spacer 56 may then be inserted into the insulated collar 54 and a male thread 57 on the collar 54 screwed into a complementary female thread 53 within the housing 50 until the flange 66 bottoms against the conductive surface 88. The lamp assembly 52, spacer 56 and nonconducting, insulating collar 54 assembled into the housing 50 form the lamp holder assembly 32.

The lamp holder assembly 32 may then be assembled to the reflector 30. To this end, a female thread 31 within the reflector 30 is screwed onto a male thread 51 on the housing 50 to form the light assembly 28.

The light assembly 28 is then assembled into the flashlight housing 20 by inserting the light assembly 28 into the enlarged diameter end 20a until the spacer 56 contacts the positive terminal 23 of the battery 22 after which the retaining ring 34 is placed over the reflector 30. A female thread 33 within the retaining ring engages a male thread 19 on the flashlight body to complete assembly of the flashlight 10. Once inserted into the flashlight body 20, a flange 29 of the reflector 30 forms an electrical contact with a moveable contact 21. The switch 26 then completes the circuit back to the negative terminal of the battery through a spring 27.

With the thus described flashlight 20 mounted on the machine gun 12 as illustrated in FIG. 1, the elements of the flashlight 10 cooperate to form a structure that is extremely resistant to vibration. For example, during detonation of a cartridge, the backward impulse causes the batteries to surge forward against the spacer 56. However, the spacer flange 66 presses directly against the shoulder 62 through the periphery of the circuit board 84 transferring the impulse energy into the impulse housing 50. The impulse housing 50, in turn, transfers the energy to the reflector 30 and in turn to the body 20 via operation of the retaining ring 34.

The circuit board 84 does not receive any significant stress or vibrating impulse forces normal to the surfaces 84a,b (i.e. in the direction of light transmission) except for the weight of the lamp 70. The lamp 70, in turn, resists the impulse energy forces, and thus the tendency to pull the leads 74, 76 out of the circuit board 84, because of the conductive glue 90 securing the leads 74, 76 into the receptacles 80, 82.

The use of the glue 90 in the flashlight 10 differs from the prior use of such glues for a number of reasons. For example, the prior uses of such glues have been in the context of a primary attachment and connection mechanism in the assembly and repair of flexible circuits or for electronic shielding. In contrast, the glue 90 of the flashlight 10 is used as an auxiliary mechanism for securing the leads of the lamp 70 to the receptacles 80, 82 and for maintaining electrical contact.

Further, the glue 90 is used within the receptacles to resist shearing action. However, the mechanism that allows the glue 90 to perform so successfully is not limited exclusively to its ability to resist shear. For example, as with most mechanical devices, the receptacles 80, 82 are created with certain manufacturing tolerances, including variations in diameter and wall consistency along the length of the receptacle apertures. The leads 74, 76 are subject to the same variations. In effect the variations in diameter and wall surface consistency operate to create a large number of attachment points that directly resist lead pull-out and which can also contribute to a wedging effect. The glue 90 within the receptacle 80, 82 is believed to interact with the variations due to manufacturing tolerances to form an in-situ locking mechanism that would not exist in other contexts. The interaction of the glue 90 with the receptacles 80, 82 and leads 74, 76 results in a bonding mechanism that far exceeds the tensile and shear strengths of the glue 90 by itself.

Still further, the flexibility of the glue 90 allows the glue to absorb the shock generated by gunfire without fracturing or separating. The result is an extremely durable bond between the leads 74, 76 and the receptacles 80, 82 that prevents the lamp leads from being ejected from the receptacles when subjected to the shock forces created by firing the machine gun.

While a preferred embodiment of the present invention has been illustrated and described, it will be understood that changes and modifications may be made therein without departing from the invention in its broader aspects. Various features of the invention are defined in the following claims.

1. A method of securing a lamp having a pair of conductive leads within a flashlight, such method comprising the steps of:
providing a pair of lamp lead receptacles each of which has an aperture adapted to receive a lamp conductive lead, securing said receptacle in parallel relation to a primary axis of light emission from the lamp;
disposing a lead of the lamp in each of the pair of lamp lead receptacles; and
securing the leads of the lamp within the receptacles using a conductive adhesive.

2. The method as defined in claim 1 including the further step of supporting the lamp lead receptacles in a printed circuit board.

3. The method as defined in claim 2 including the further step of orienting the printed circuit board at a right angle to the predominant axis of emission of the lamp.

4. The method as defined in claim 3 further comprising disposing a conductive coating on first and second sides of the printed circuit board with the conductive coating on the first side electrically coupled to a first lead of the lamp and the conductive coating on the second side electrically coupled to a second lead of the lamp.

5. The method as defined in claim 5 further comprising disposing the printed circuit board against an impulse housing that forms an electrical contact with the first side of the printed circuit board and that absorbs impulse energy directed along an axis of light emission of the lamp.

6. The method as defined in claim 5 further comprising disposing a conductive spacer against the conductive surface on the second side of the printed circuit board to form an electrical contact with the second side of the printed circuit board.

7. The method as defined in claim 6 further comprising centering the conductive spacer using an insulating collar.

8. The method as defined in claim 7 further comprising disposing a battery of the flashlight against the conductive spacer.

9. An apparatus for securing a lamp having a pair of leads within a flashlight, such apparatus comprising:
a pair of lamp lead receptacles each of which has an aperture adapted to receive a lamp lead, the receptacles being disposed so that said apertures are in parallel relation to a primary axis of light emission from the flashlight;
a lead of the lamp being disposed in each of the pair of lamp lead receptacles; and
a conductive adhesive securing the leads of the lamp within the receptacles.

10. The apparatus as defined in claim 9 further comprising a printed circuit board adapted to support the pair of lamp lead receptacles.

11. The apparatus as defined in claim 10 wherein the printed circuit board further comprises a right angle orientation with respect to the predominant axis of emission of the lamp.

12. The apparatus as defined in claim 11 further comprising a conductive coating disposed on each of a first and a second side of the printed circuit board with the conductive coating on the first side coupled to a first lead of the lamp and the conductive coating on the second side coupled to a second lead of the lamp.

13. The apparatus as defined in claim 12 further comprising an impulse housing that forms an electrical contact with the first side of the printed circuit board and that absorbs impulse energy directed along an axis of emission of the flashlight.

14. The apparatus as defined in claim 13 further comprising a conductive spacer disposed against the conductive surface on the second side of the printed circuit board to form an electrical contact with the second side of the printed circuit board.

15. The apparatus as defined in claim 14 further comprising an insulating collar adapted to center the conductive spacer.

16. The apparatus as defined in claim 15 further comprising a battery disposed against the conductive spacer.

17. A flashlight for use in environments with relatively high levels of vibration forces acting parallel to a predominant axis of light emission of the flashlight, such flashlight comprising:
a lamp having a pair of leads extending rearwardly from the lamp parallel to the predominant axis of light emission;
a printed circuit board disposed perpendicular to the predominant axis of transmission;
a pair of receptacles disposed in the printed circuit board and adapted to receive the pair of leads of the lamp; and
a conductive adhesive disposed within the receptacles to secure the leads of the lamp within the receptacles of the printed circuit board.

18. The flashlight as defined in claim 17 further comprising an elastomeric collar surrounding a lower portion of the lamp adjacent the printed circuit board.

19. The flashlight as defined in claim 17 wherein the printed circuit board includes an electrically conductive plating material disposed on a first side of the printed circuit board and forming a contact with a selected one of the pair of receptacles.

20. The flashlight as defined in claim 19 wherein the printed circuit board further includes an electrically conductive plating material disposed on a second side of the printed circuit board and forming a contact with the other receptacle of the pair of receptacles.

21. The flashlight as defined in claim 20 further comprising a tubular housing for supporting the lamp and printed circuit board.

22. The flashlight as defined in claim 21 wherein the tubular mounting assembly further comprises a shoulder that divides a center passageway of the housing into a lamp portion and a printed circuit board section, the shoulder forming an electrical contact between the tubular housing and the first side of the circuit board.

23. The flashlight as in claim 22 wherein the tubular housing further comprises a female thread disposed on an inside surface of the circuit board section.

24. The flashlight as defined in claim 23 further comprising a spacer with an outwardly extending flange adapted to form an electrical contact with a second side of the printed circuit board.

25. The flashlight as defined in claim 24 wherein the housing further comprises an insulating collar with a set of external threads adapted to engage the female thread on the inside surface of the circuit board section of the tubular housing, said spacer being sized to extend through a center aperture of the insulating collar, said insulating collar being adapted to engage the outwardly extending shoulder of the spacer to bias the spacer against the second side of the printed circuit board.

26. The flashlight as defined in claim 17 wherein the housing further comprises an external thread adjacent the lamp end.

27. The flashlight as defined in claim 26 further comprising a reflector with a base of the reflector containing an internal thread adapted to engage the external thread of the tubular housing.

28. A method of securing a lamp having a pair of conductive leads within a flashlight, such method comprising the steps of:
providing a pair of lamp lead receptacles each of which has an aperture adapted to receive a lamp conductive lead in parallel relation to a primary axis of light emission from the lamp; and
securing a lead of the lamp within one of the receptacles using a conductive adhesive after the leads of the lamp have been disposed within the pair of lamp lead receptacles.
